(19) United States
(12) Patent Application Publication
(10) Pub. No.: US 2008/0040229 A1
(43) Pub. Date: Feb. 14, 2008

(54) System and method for distributing a right to transmit an electronic coupon to mobile devices

(76) Inventor: Howard V. Gholston, Chandler, AZ (US)

Correspondence Address: BRYAN CAVE LLP, TWO NORTH CENTRAL AVENUE, SUITE 2200, PHOENIX, AZ, 85004, US

(21) Appl. No.: 11/891,945

(22) Filed: Aug. 13, 2007

Related U.S. Application Data
(60) Provisional application No. 60/837,421, filed on Aug. 12, 2006.

(51) Int. Cl. G06Q 30/00

(52) U.S. Cl. 705/14

(57) ABSTRACT

Embodiments of systems and methods for distributing a right to transmit an electronic coupon to mobile devices are generally described herein. In one embodiment, the method includes auctioning the right to transmit the electronic coupon to the mobile devices at one or more predetermined locations at one or more predetermined times on one or more predetermined days. The method also includes receiving one or more bids from one or more parties to acquire the right, and distributing the right to a party of the one or more parties proposing a bid of the one or more bids having a predetermined characteristic. Other embodiments are also described and claimed.

### CROSS-REFERENCE TO RELATED APPLICATION

This application claims the benefit of U.S. Provisional Application Ser. No. 60/837,421, filed Aug. 12, 2006, which is incorporated herein by reference.

### TECHNICAL FIELD

This disclosure relates generally to coupons, and relates more particularly to systems and methods for distributing electronic coupons to mobile devices.

### BACKGROUND

Businesses distribute more than 300 billion coupons each year in the United States, and these coupons can save people nearly $3 billion each year. Electronic coupons can be emailed, downloaded, and stored onto potential consumers' desktop computers and also to potential consumers' cell phones, laptops, personal digital assistants (PDAs), and other mobile devices. Electronic coupons can also be retrieved and printed from Internet websites. Techniques for distributing paper coupons have been modified to distribute electronic coupons, but these traditional distribution models or paradigms fail to take advantage of the more flexible, versatile, and dynamic nature of electronic coupons.

### BRIEF DESCRIPTION OF THE DRAWINGS

FIG. 1 illustrates a block diagram of a system having two markets for creating and distributing exchange traded products, according to an embodiment;

FIG. 2 illustrates a block diagram of the exchange traded products of FIG. 1;

FIG. 3 illustrates a block diagram of a system for using the exchange traded products of FIGS. 1 and 2;

FIG. 4 illustrates a flow chart for a method for distributing a right to transmit an electronic coupon to mobile devices, according to an embodiment;

FIG. 5 illustrates a flow chart for a method for distributing a right to transmit an advertisement with an electronic coupon to mobile devices, according to an embodiment;

FIG. 6 illustrates a flow chart for a method for distributing a right to transmit an electronic coupon to mobile devices, according to an embodiment;

FIG. 7 illustrates a flow chart for a method for distributing a right to transmit an advertisement with an electronic coupon to mobile devices, according to an embodiment; and

FIG. 8 illustrates a flow chart for a method of distributing electronic coupons to mobile devices, according to an embodiment.

For simplicity and clarity of illustration, the drawing figures illustrate the general manner of construction, and descriptions and details of well-known features and techniques may be omitted to avoid unnecessarily obscuring systems and methods described herein. Additionally, elements in the drawing figures are not necessarily drawn to scale. For example, the dimensions of some of the elements in the figures may be exaggerated relative to other elements to help improve understanding of embodiments of the systems and methods described herein. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of systems and methods described herein are, for example, capable of operation in sequences other than those illustrated or otherwise described herein. Furthermore, the terms “contain,” “include,” and “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus. The term “coupled,” as used herein, is defined as directly or indirectly connected in an electrical, physical, mechanical, or other manner.

### DESCRIPTION OF EXAMPLES OF EMBODIMENTS

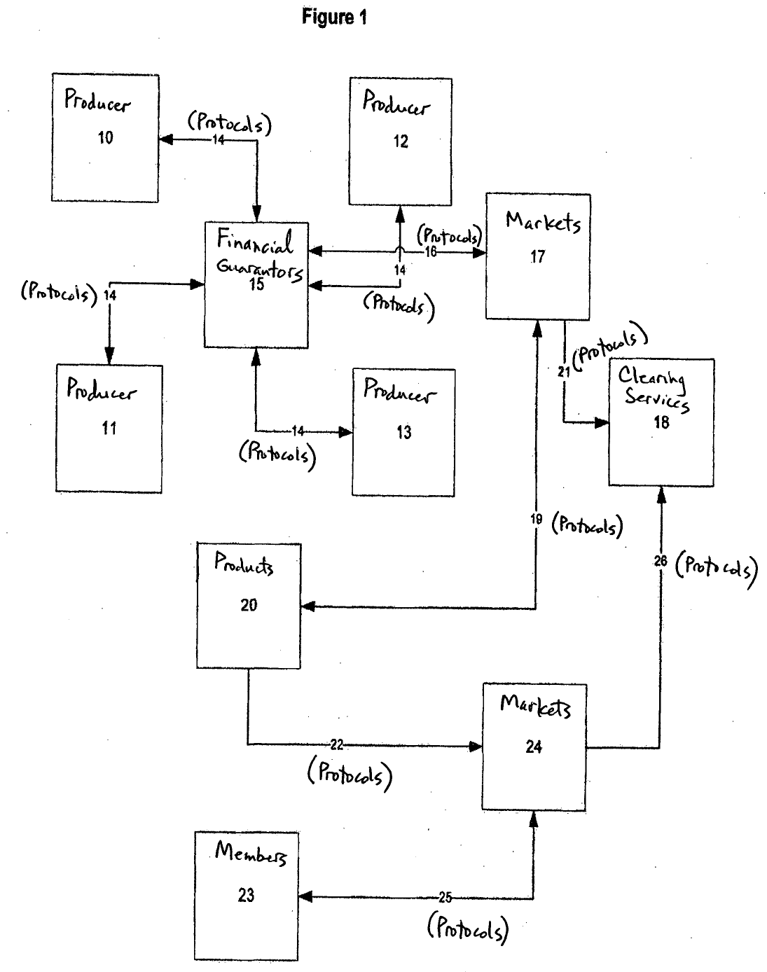

FIG. 1 is a block diagram illustrating producers 10, 11, 12, and 13 operating in a state or combination of states such as, for example, capacity, supply, demand, and/or inventory. For example, producer 10 can take one or more positions in a variable state or a combination of variable states like capacity and/or supply, and producer 11 can take one or more positions in a variable state or a combination of variable states like capacity and/or demand. In this same example, producer 12 can take one or more positions in a variable state or a combination of variable states in inventory and/or supply, and a producer 13 can take one or more positions in a variable state or a combination of variable states in inventory and/or demand. More or less than four producers can participate in the system described below. Other variations are also contemplated.

A producer can be a provider of goods and/or services, and the producer can do business as a manufacturer, wholesaler, retailer, distributor, and/or reseller. In general, a producer can be an entity with a product or service for another producer or for a consumer. Therefore, a producer can be a manufacturer, a retailer, an aggregator, a distributor, a marketing agency, a broadcaster, a content provider, a content producer, or the like.

In one embodiment, the positions of producers 10, 11, 12, and 13 represent their rights to receive, obligations to deliver, or claims to hold benefits of goods and/or services produced by the underlying assets. As an example, a producer's position can represent that producer's ability to provide goods and/or services produced by the producer's underlying capital assets at an opening price. The underlying assets can include buildings, facilities, raw materials, parts, and/or tools used as part of the producer's business. The producer can own or control its underlying assets. The opening price can be represented in terms of an amount expressed as money, currency, or an item of value in any economy.

Producers 10, 11, 12, and 13 submit their positions through protocols 14 to one or more financial guarantors 15. As an example, protocols 14 can be one or more computer networks, telephone connections, and/or written documents. Financial guarantors 15 can serve as financial backers, insurers, brokers, or agents acting on behalf of their producer clients to show proof of worthiness. Financial guarantors 15 can be non-producers or holders of rights from producers 10, 11, 12, and/or 13. In this example, financial guarantors 15 might not have a product or service to sell, license, or lend to consumers, but can be considered market-makers. If not demonstratively self-insured, all of producers 10, 11, 12, and 13 can be pre-qualified by, accredited by, and listed with financial guarantors 15.

Financial guarantors 15 accept or reject, and approve or deny, positions of producers 10, 11, 12, and/or 13 for markets 17. In one embodiment, markets 17 can be referred to as primary markets, and in another embodiment, markets 17 can include primary auctions. Markets 17 can use automated trading algorithms and can be similar to computerized auctions.

In a different embodiment, one or more of producers 10, 11, 12, and 13 are self-insured producers that do not need to use financial guarantors 15. Producers 10, 11, 12, and/or 13 who are self-insured can participate directly in markets 17. In another embodiment, if only producer 10 is self-insured, producer 10 can serve as a financial guarantor for producers 11, 12, and 13. Other variations are also contemplated.

Markets 17 can include the sale of at least one position to the highest bidding producer of producers 10, 11, 12, and 13. The bids can be automatically generated by a third party, advanced or declined by a counter party, or initiated by a first party to any degree or by any extent. Financial guarantors 15 can submit, place, and secure the accepted and approved positions through protocols 16. In an embodiment where one or more of producers 10, 11, 12, and 13 are self-insured, the self-insured producers of producers 10, 11, 12, and 13 can directly submit, place, and secure the accepted and approved positions through protocols 16, without using financial guarantors 15.

The positions of producers 10, 11, 12, and 13 are entered into markets 17, which can include auctions. One or more of producers 10, 11, 12, and 13 can enter subjective information about their respective positions, and one or more of producers 10, 11, 12, and 13 can also enter objective, risk-neutral indices or survey results about their respective positions. Each auctioned position can have a financial value. The unaccepted and unapproved positions can be rerouted through protocols 14. The initial financial values of the positions can increase or decrease in financial value depending on the ongoing activities of producers 10, 11, 12, and/or 13 and/or other producers entering their own respective positions. The changes in financial value of the positions depend upon the varying volatility of increasing (up) or decreasing (down) states of the positions.

As indicated above, markets 17 are between producers 10, 11, 12, and 13. In one embodiment, markets 17 can be referred to as primary markets that are limited to only producers such as producers 10, 11, 12, and 13. Producers 10, 11, 12, and 13 have interests in varying states of their respective positions, and producers 10, 11, 12, and 13 have a need to deliver or receive interests associated with their respective positions in markets 17. The rights and obligations of producers 10, 11, 12, and 13 to goods and/or services produced by their respective underlying assets can be traded in markets 17. The options to exercise rights and obligations of producers 10, 11, 12, and 13 to goods and/or services produced by their respective underlying assets can also be traded in markets 17.

The positions of producers 10, 11, 12, and 13 are confirmed in markets 17. Producers 10, 11, 12, and 13 receive daily gains and/or losses in their accounts, and producers 10, 11, 12, and 13 give collateral to financial guarantors 15 or other self-insured ones of producers 10, 11, 12, and 13 on their respective positions.

Financial guarantors 15 and the self-insured ones of producers 10, 11, 12, and 13 ensure positions and oversee terms between parties participating in markets 17. Each auctioned position, backed by a financial guarantor or self-insured producer, represents an opened position to: (a) buy at a corresponding price known as the asking price; or (b) sell at a corresponding price known as the offering price.

Markets 17 can use automated trading algorithms to optimize prices and match positions. The parties operating markets 17 and/or licensing software to run markets 17 can also be considered market-makers. A matched position in markets 17 can activate an exchange traded product 20 through protocols 19. Exchange traded products 20 can be written contracts, agreements, or instruments describing the rights, obligations, or claims exercised or acted upon to buy or sell goods and/or services. A pair of opening positions having commensurate asking prices and offering prices is a matched position that can be a component of an exchange traded product, such as exchange traded product 20.

Unmatched positions in markets 17 are declined and sent through protocols 21 to clearing services 18. Protocols 21 can be similar to or serve a similar purpose as protocols 14 and 19. Clearing services 18 can be vendors, suppliers, or entities that handle the administration of clearing positions. As an example, producer 10 can offset its opening position by entering an equal and/or opposite position at a closing price that, in turn, is: (a) accepted by one of financial guarantor 15 or a self-insured one of producers 11, 12, or 13; (b) submitted to an auction; or (c) matched by one of producers 11, 12, or 13.

In one embodiment, a closing price can be the opposite of an opening price and can only occur after an established opening price. That is, one opening position by one producer to buy followed by one opening position to sell by the same producer is equivalent to one closing position and is rerouted through protocols 19. Similarly, one opening position by one producer to sell followed by one opening position to buy by the same producer is also equivalent to one closing position and is also rerouted through protocols 19.

Trading symbols can be generated after exchange traded products 20 are activated, and the trading symbols can be placed in markets 24 via protocols 22. Protocols 22 can be similar in function and purpose to protocols 14, 16, 19, and/or 21. In one embodiment, markets 24 can be referred to as secondary markets, and in another embodiment, markets 24 can include second level auctions. Markets 24 can use automated trading algorithms and can be similar to computerized auctions.

Members 23 can trade exchange traded products 20 in markets 24. Members 23 can come together to deliberate, invest, or speculate about the financial value of exchange traded products 20. Members 23 can include non-producers and producers. Non-producers can include, but are not limited to, financial guarantors, self-insurers, brokers, dealers, market makers, arbitrageurs, merchant banks, factoring services, payment services, advertisers, and individuals or entities who are investing, hedging, or speculating in the values of exchange traded products 20.

Members 23 submit buy (or sell) orders to markets 24 via protocols 25 at an opening process. Members 23 with matched orders become owners or holders of exchange traded products 20. Members 23 that are owners or holders of exchange traded products 20 are also able to offset ownership or holding by submitting equal and opposite orders at closing prices.

Unmatched orders from members 23 are declined by automated trading algorithms and routed via protocols 26 to clearing services 18. Protocols 26 can be similar to protocols 14, 16, 19, 21, 22, and 25. Then, terminated ownership is rerouted via protocols 25 to those members of members 23 who submitted the unmatched orders.

In one embodiment, all actively traded exchange traded products 20 have at least one holder from the pool of members 20. The financial value of ownership of an exchange traded product within exchange traded products 20 will increase or decrease as volatility varies in pricing of exchange traded product 20.

The positions of producers 10, 11, 12, and/or 13 can beget indices, and the positions of producers 10, 11, 12, and/or 13 can also be indexed by those indices based on economic, industry, and other information. Exchange traded products 20 can be built-in to or from those indices and the positions of producers 10, 11, 12, and/or 13. The creation and codification of exchange traded products 20 have the positions of producers 10, 11, 12, and 13 inherently embedded in them, although exchange traded products 20 can also have other producers' positions inherently embedded in them. Stated differently, the positions of producers 10, 11, 12, and 13 (and any other producers participating in markets 17) can be derived from exchange traded products 20. Exchange traded products 20 are traded among producers 10, 11, 12, and 13 in markets 17 and are subsequently traded by members 23 in markets 24.

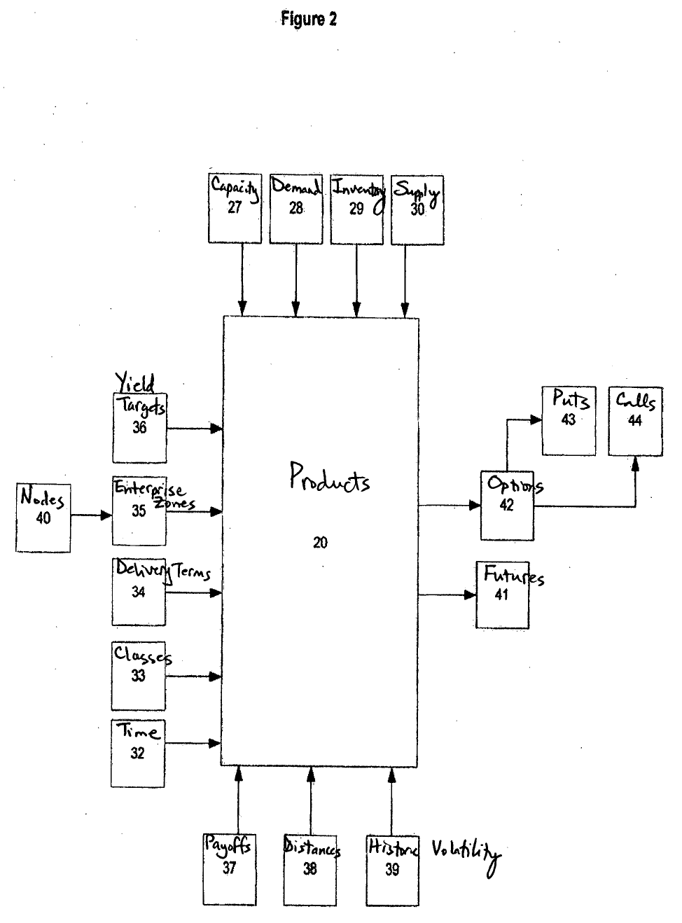

In one embodiment, each one of exchange traded products 20 has variable states. These variable states are inputs to set opening prices for exchange traded products 20. As illustrated in FIG. 2, examples of these variable states include degrees, ranges, and/or levels of capacity 27, demand 28, inventory 29, and supply 30 to just name a few. These four variable states do not exhaust the possible number of variable states, as other possible variable states can include, for example, market share, operating margins, costs of doing business, and expenses due to business interruptions or cyclical seasons. The variable states or inputs can replicate the positions of producers 10, 11, 12, and/or 13 (FIG. 1) in the form of exchange traded products 20.

The combinations of different states are variables that represent the financial values of the positions of producers 10, 11, 12, and/or 13 (FIG. 1). The variable states or inputs are modeled and monetized to determine the pricing of exchange traded products 20, and therefore, the changes in the variable states influence the changes in the financial values of exchange traded products 20. For example, the variable states can change by going up to higher numerical or categorical values, or the variable states can change by going down to lower numerical or categorical values, by any extent throughout the life of exchange traded products 20. Thus, this changing of the variable states creates liquidity for the positions of producers 10, 11, 12, and/or 13 (FIG. 1) and owners that are members 23 (FIG. 1) of exchange traded products 20. The creation of liquidity effectively frees up monies from untapped resources or under utilized assets.

Continuing with FIG. 2, time variables 32 can also be embedded into exchange traded products 20. Time can be any fixed, predetermined, or specific calendar day, month, and/or year. Time variables can be specific dates and times, specific continuous dates and times, or specific ranges of dates and times. As an example, the time variables can be used for activating and terminating exchange traded products 20 at specific dates and times, including issue dates, vesting dates, and expiration dates. The ranges of dates and times can be partitioned for settling the maturity or expiry periods for exchange traded products 20. Settling can occur on any calendar day, month, or year. The nature of such calendar specifics, however, can be characterized on a time basis, a usage basis (i.e., the use of something), and/or an event basis (i.e., the occurrence of something).

In one embodiment, exchange traded products 20 are instruments owned by members 23 (FIG. 1) who have privileges and benefits of exercising claims to goods and/or services produced by underlying assets of producers 10, 11, 12, and/or 13 (FIG. 1). The claims on rights can be settled in cash akin to futures and options in the stock market example described below.

Classes 33 of exchange traded products 20 can describe the quality and quantity of the claims. Classes 33 can be standardized and denominated. Delivery terms 34 of exchange traded products 20 can be instructions for handling and carrying out the claims (i.e., how goods and/or services are received and delivered), and enterprise zones 35 can be characteristics of exchange traded products 20 that define geo-spatial boundaries.

Each of enterprise zones 35 can be made up of a mapping of nodes 40. In some embodiments, nodes 40 can also be referred to as joints, interconnects, or points. Each of enterprise zones 35 can be a point of any size, a line of any size, a plane of any size, and/or a surface of any size, order, and dimension to form definable, real or imaginary boundaries, objects, or spaces. The scope of any real or imaginary coordinate system can be expressed as one or many dimensions, including dimensions greater than three dimensions. Inter- and intra-enterprise zones can be regular or irregular spaced. Each of enterprise zones 35 can be of any size or shape or measure of one or more coordinate systems of any kind like, for example, spherical, rectangular, or spatial systems. Repeating or non-repeating segments and overlaying or non-overlaying patterns can exist in each coordinate system. The geo-spatial boundaries of enterprise zones 35 are constructed or transformed from or to unique geo-spatial coordinates (e.g., longitude, latitude, and attitude).

Exchange traded products 20 can be designed to target consumers at a particular locale, as stipulated in applying delivery terms 34. These elements are known as yield targets 36. Yield targets 36 can be determined, calculated, or forecasted numerical expressions. Yield targets 36 can be optimized to yield the highest population of consumers per unit area or density per each one of enterprise zones 35.

Exchange traded products 20 are deployed in the marketplace. Payoffs 37 of exchange traded products 20 set the conditions for either profits or losses. Profits and losses can be the values realized on exchange traded products 20 minus the costs or premiums of exchange traded products 20. Profits and loses can be calculated from par prices, market prices, exercisable prices, discounting rates, factoring rates, and funding costs such as the amounts of initiation, maintenance, and/or settlement fees. Exchange traded products 20 account for distances 38 between producers 10, 11, 12, and/or 13 (FIG. 1). Historical volatility 39 can be calculated, tracked, and projected in order to establish up-to-date pricing of exchange traded products 20.

In one embodiment, all inputs, components, elements, etc. of exchange traded products 20 influence the values of exchange traded products 20. In fact, the inputs, components, elements, etc. begin affecting the values of exchange traded products 20 immediately upon the creation of exchange traded products 20 because their values are subject to changes in their respective inputs, components, elements, etc. until exchange traded products 20 expire.

Exchange traded products 20 can be considered instruments, and as such, these instruments can be deployed in two types of classifications: futures contracts 41 and options contracts 42. Options contracts 42 can come in two types of classifications: puts 43 and calls 44.

Futures contracts 41 are legally binding agreements to buy or sell goods and/or services from underlying assets of producers 10, 11, 12, and/or 13 (FIG. 1) in the future. In one embodiment, futures contracts 41 can be standardized and specified according to the quality, quantity, delivery and locality corresponding to enterprise zones 35 per specific goods and/or services. In this embodiment, each of futures contracts 41 can still vary by price, which can be set at the onset of each of futures contracts 41 upon a matched position between a buyer and seller of one of exchange traded products 20 in markets 17 or 24 (FIG. 1).

As an example, some owners of members 23 (FIG. 1) of exchange traded products 20 can send and/or receive physical delivery of goods and/or services or their underlying assets to produce such goods and/or services. This sending and/or receiving can be constrained by certain expiration dates and under certain terms of exchange traded products 20 that can be voided only if deactivated ones of exchange traded products 20 exist. Producers 10, 11, 12, and/or 13 (FIG. 1) and/or owners of members 23 (FIG. 1) can deactivate certain ones of exchange traded products 20 by offsetting their respective positions and/or exchange traded products 20 prior to expiry. Futures contracts 41 can be used for speculation or hedging.

Options contracts 42 can be defined as rights, but not the obligations, to carry out transactions that, in effect, create options for their owners or members 23 (FIG. 1). In a first embodiment, options contracts 42 include real options, which are and can be applied to capital assets in business, because options contracts 42 pertain to physical or tangible assets. In a second embodiment, options contracts 42 can be applied to intangible, strategic, or virtual capital assets. In the second embodiment, options contracts 42 are also considered to be real options because they give rights, but not obligations, to undertake, delay, and/or forgo business decisions and/or actions on resources at predetermined costs for predetermined periods of time. In a third embodiment, options contracts 42 can include both types of options described in the first and second embodiments.

In one embodiment, members 23 (FIG. 1) that are owners of exchange traded products 20 can be beneficiaries of a single one of options contracts 42 of an increase, decrease, or both in capacity 27, demand 28, inventory 29, and/or supply 30 of any goods and/or services assigned. In a different embodiment, members 23 (FIG. 1) that are owners of exchange traded products 20 can be beneficiaries of multiple ones of options contracts 42 of an increase, decrease, or both in capacity 27, demand 28, inventory 29, and/or supply 30 of any goods and/or services assigned. In another embodiment, members 23 (FIG. 1) that are owners of exchange traded products 20 can be beneficiaries of both a single one and multiple ones of option contracts 42. Options contracts 42 can be: (a) unrestricted or restricted options to act on assets; (b) compounded options; (c) options on futures; or (d) options on options. Options contracts 42 are traded, i.e., producers 10, 11, 12, and/or 13 can sell the rights to claims to other parties.

Puts 43 allow buyers the rights, but not the obligations, to sell a predetermined quantity of exchange traded products 20 to sellers of options contracts 42 at a certain time for a specific price. Calls 44 allow buyers the rights, but not the obligations, to buy a predetermined quantity of exchange traded products 20 from sellers of options contracts 42 at a certain time for a specific price. The sellers have the obligation to purchase at their exercise prices, if the buyers choose to exercise the options. The buyers and sellers are part of members 23 (FIG. 1). The behaviors of futures contracts 41 and options contracts 42 herein are germane to behaviors of financial futures and options contracts and other derivatives.

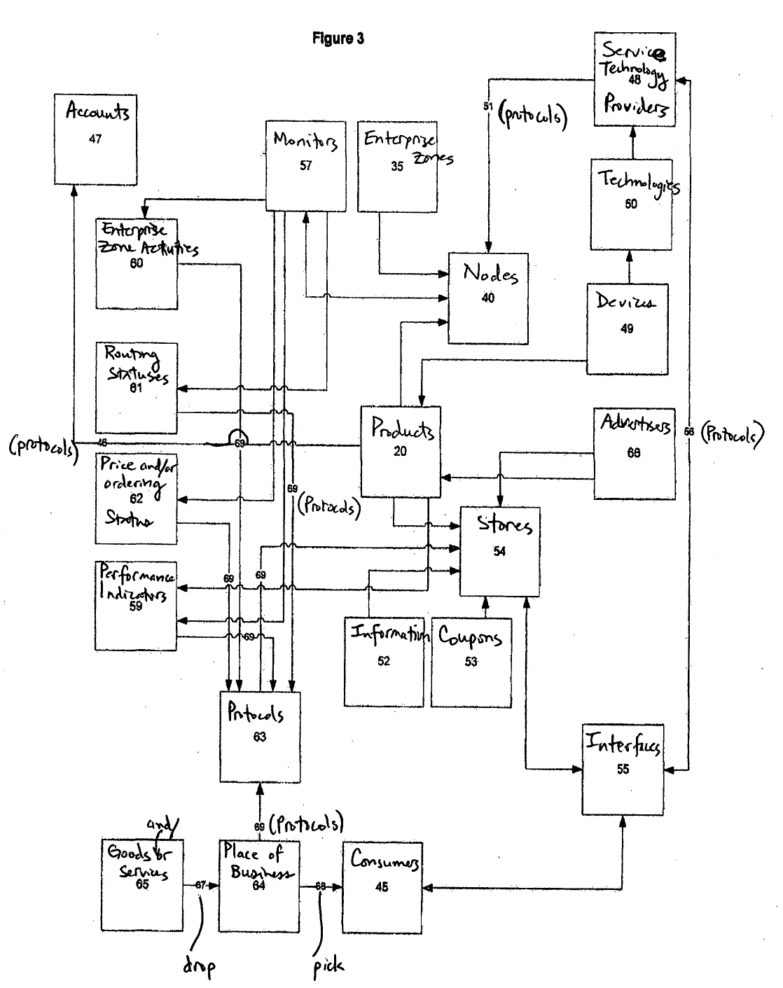

Turning to FIG. 3, consumers 45 who travel in the vicinity or proximity of enterprise zones 35 (FIG. 2) purchase physical goods and/or services 65 from producers 10, 11, 12, and/or 13 (FIG. 1) that have outstanding obligations according to rights of members 23 (FIG. 1) who are outstanding owners of residual or unmet interests related to exchange traded products 20. As illustrated in FIG. 3, exchange traded products 20 can be executed in a third level market, which can be a tertiary market of consumers 45 and producers 10, 11, 12, and/or 13 (FIG. 1) where goods and/or services 65 are purchased at a fixed price and payments are sent via protocols 46 to accounts 47 of members 23 (FIG. 1). Examples of accounts 47 include: federally insured bank checking and saving accounts, uninsured repository of funds, and any form of an account for deposits.

Nodes 40 can notify consumers 45 of the arrival or presence of goods and/or services 65. Nodes 40 can include wireless or wired connections for detecting the arrival or presence of the goods and/or services 65. Nodes 40 also include beacons, access points, or other devices to generate signals. Consumers 45 can access nodes 40 through location-based service technology providers 48, which are coupled to nodes 40 via protocols 51.

Consumers 45 can utilize devices 49 to couple to location-based service technology providers 48 via location-determining technologies 50. Devices 49 can include phones, computing devices, or other stationary or non-stationary electronic machines enabled for fixed, portable, and/or mobile worldwide interoperability for microwave access or other wireless technologies. Location-determining technologies 50 can include satellite positioning systems, base stations, antennas, transmitters, receivers, and/or stored location coordinates.

In a different embodiment, the system and method described herein can exclude wireless technology. In this embodiment, devices 49 can be coupled to nodes 40 via protocols 51 by way of wires, such as cables, fiber optics, or conduits of conductive materials. In another embodiment, the system and method described herein can exclude location-determining technologies 50. In this embodiment, any intelligible procedures of gathering knowledge of locations such as radio frequency or infrared identification, near field communication, machine learning model construction, and/or person-to-person, person-to-device, device-to-person or device-to-device viral transmissions can be used.

Exchange traded products 20 are exercised in the tertiary markets, and the monetary values of exchange traded products 20 in the tertiary markets are realized as spot values. Spot values can be the now, immediate, or instantaneous price of goods and/or services 65. Producers 10, 11, 12, and/or 13 (FIG. 1) who own exchange traded products 20 provide goods and/or services 65 produced by their underlying assets that have been ascribed to active exchange traded products 20. Goods and/or services 65 contracted in active exchange traded products 20 are made available to consumers 45 to purchase and, then, sold to consumers 45 under terms of exchange traded products 20.

In one embodiment, each of exchange traded products 20 to be exercised in the tertiary market of FIG. 3 must have at least one remaining producer (i.e., one of producers 10, 11, 12, and/or 13) contracted and obligated to deliver goods and/or services 65 to consumers 45 before or at maturity of such exchange traded products 20. Goods and/or services 65 can be provided to and purchased by consumers 45 through devices identified and located in uniquely defined enterprise zones 35 (FIG. 2). Consumers 45 can purchase goods and/or services 65 at discrete locations as previously conveyed through terms of exchange traded products 20. Goods and/or services 65 purchased by consumers 45 from producers have perishable and non-perishable qualities by nature and can be for finite quantities and for specified periods of time. For example, exchange traded products 20 at maturity can act like future contracts 41 (FIG. 2) between producers 10, 11, 12, and/or 13 (FIG. 1) and members 23 (FIG. 1), and profits and losses depend on settlement charges, including monies passed from consumers 45, advertisers, and subsidizers prior to their expiries.

The tertiary markets are activities between consumers 45 and producers 10, 11, 12, and/or 13. Consumers 45 can receive text, audio and/or video editions of information 52 distributed in any media format, whether downloaded, stored or linked from remote, local, or virtual stores 54 via live or passive interfaces 55 partially or fully coupled through protocols 56 serviced by location-based service technology providers 48. Examples of information 52 includes electronic advertisements and digital products. Consumers 45 also can receive coupons 53 of any media format, whether downloaded, stored or linked from remote, local, or virtual stores 54 via live or passive interfaces 55 partially or fully coupled through protocols 56 serviced by location-based service technology providers 48. Media formats of information 52 and coupons 53 can be songs, games, movies, and so forth. Consumers 45 are also authenticated with location-based service technology providers 48 including, but not limited to, the use of bar code readings, pin-alpha-numerics, and/or smart cards.

Interfaces or monitors can show all services used, offers received, and available real-time data, streamed data, or periodically updated information required to purchase goods and/or services 65. Consumers 45 can be tracked using monitors 57. Monitors 57 can verify payments from consumers 45 and can confirm obligations of producers 10, 11, 12, and/or 13 (FIG. 1). Monitors 57 can also send failed commitments and transactions to clearing services 18 (FIG. 1) for arbitration, and monitors 57 can track consumers 45 and producers 10, 11, 12, and/or 13 through nodes 40. Monitors 57 can track the progression or lack of progression of transactions between consumers 45 and producers 10, 11, 12, and/or 13 (FIG. 1) ranging from purchasing to delivering goods and/or services 65. Monitors 57 can also post statuses of purchases and deliveries.

Producers 10, 11, 12, and/or 13 can view tertiary market conditions through interfaces, which include, as an example: performance indicators 59 (i.e., in the money, at money, out of money, price to revenue, price to expense, etc.) of exchange traded products 20; real-time enterprise zone activities 60; consumer routing statuses 61; and pricing and/or ordering statuses 62. Other types of interfaces can also be used, and more or less than four interfaces can be used.

The interfaces can be unattached, attached, or integrated with place-of-doing-business protocols 63 of producers 10, 11, 12, and/or 13, and the interfaces can be distributed, connected, or handled through other protocols 69 to physical places of business 64. For example, physical places of doing business 64 can include: (a) brick and mortal buildings; (b) persons at places of doing tasks and transactions for the sake of entities on behalf of producers 10, 11, 12 and/or 13; and/or (c) machines at places of doing tasks and transactions for the sake of entities on behalf of producers 10, 11, 12 and/or 13. As an example, telephone discourses, recorded documents, invoices, receipts, cash machines, payment processing terminals, inventory management systems, and accounting systems can act as protocols 63 at any of the places of doing business 64.

Consumers 45 can purchase goods and/or services 65 from stores 54 through interfaces 55. Consumers 45 can purchase goods and/or services 65 with payment methods like credit cards, cash, e-commerce, electronic payments, mobile handset payments, etc. Examples of electronic payment (e-payment) systems include, but are not limited to, PayPal, Visa, MasterCard, Discover, American Express, and GratisCard.

Consumers 45 can receive goods and/or services 65 at the places of business 64 of producers 10, 11, 12, and/or 13. Stores 54 can be literally or figuratively supplied with goods and/or services 65 from physical places of doing business 64 of producers 10, 11, 12, and/or 13. Actual operations at physical places of doing business 64 can be according to one or a combination of states like up or down capacity 27 (FIG. 2), up or down demand 28 (FIG. 2), up or down inventory 29 (FIG. 2), and/or up or down supply 30 (FIG. 2). Positions of producers 10, 11, 12, and/or 13 (FIG. 1) may differ from the actual states of their respective physical places of doing business 64.

Stores 54 can also offer discounted goods and/or services 65 as advertisers 66 subsidize goods and/or services 65 through advertisements, product placements, and purchase incentives and rebates. In this embodiment, consumers 45 can pay for discounted goods and/or services 65, if discounted, up to predetermined amounts, less any subsidies from advertisers 66. Advertisers 66 and their corresponding subsidies can be set forth to exact descriptions and details in exchange traded products 20. Factored into exchange traded products 20 as payment structures (i.e., pay-ins and payouts), subsidies can be garnered and attributed to payoffs 37 (FIG. 2). Effectively acting as discounts passed on to consumers, subsidies of any denomination can be paid by advertisers 66 and, subsequently, sent to accounts 47 of members 23 (FIG. 1). Bonuses, on the other hand, are also subsidies from advertisers 66 paid to producers 10, 11, 12, and/or 13, but in this case, discounts are not credited to purchases by consumers 45.

Exercised exchange traded products 20 and their owners who are members 23 (FIG. 1) can be satisfied when all monies are collected on the prescribed quantities of goods and/or services 65 required to be delivered to consumers 45 within allowable vesting periods. In one embodiment, satisfied exchange traded products 20 must have drop 67 coupled with pick 68. Drop 67 can be a delivery of; (a) goods and/or services 65 by or on behalf of producers 10, 11, 12, and/or 13; or (b) underlying assets to produce goods and/or services 65, to one or more of physical places of doing business 64. Pick 68 can be a receipt of: (a) goods and/or services 65 by consumers 45; or (b) underlying assets to produce goods and/or services 65, from one or more of physical places of doing business 65. Unsatisfied exchanged traded products 20 can result in a default that engenders and demands prompt recourse.

In one embodiment, as a result of building these place-time shares and exchange traded products, one can build an insurance product or a product that promises to pay an amount of money on a claim. As an example, place of business 64 or stores 54 can offer coupons to consumers 45 with an insurance rider backed by the exchange. Place of business 64 or stores 54 can buy a place-time share to get a location-and-time slot from the market or auction. Place of business 64 or stores 54 can also buy one of exchange traded products 20 to get one of goods and/or services 65 and one of electronic coupons 53 to auction. If place of business 64 or stores 54 does the latter, then, place of business 64 or stores 54 will be exposed to changes in how the auction values redemption rates on like ones of coupons 53 or falling prices on like ones of goods and/or services 65. If the redemption rate slips down, then, the face value of the one of coupons 53 will move up to optimize overall sales.

Consumer 45 can make a purchase with a greater discounted price. An insured one of place of business 64 or stores 54, however, will not be affected by this price degradation and will receive proceeds based on the original value of coupons 53. The insurance will pay the difference in part or full because the insurance is backed by one of member 23 who agrees to take on the risk and who is a counter-party to place of business 64 or stores 54.

Place of business 64 or stores 54, on the other hand, receive price protection. This price protection works to the counter-party's advantage too because the one of member 23 (FIG. 1) might be an advertiser who would only pay if and only if coupon redemption rates slip per their sponsorship. In the case where place of business 64 or stores 54 does not offer electronic coupons 53 to consumers 45 per se, but the advertiser still agrees to pay for a coupon rate, then consumers 45 will still purchase goods and/or services 65 at a discounted price, and the advertiser will pay the difference to the place of business 64 or stores 54. This embodiment can be considered as an insurance method, but the embodiment can also be more like a coupon subsidy rather than insurance.

In one embodiment, the system described above and with reference to FIGS. 1-3 can target mobile devices with certain coupon offers from various businesses if those mobile devices fall within a predetermined perimeter of a predetermined location at a predetermined time on a predetermined day. For example, if a baseball game at a ballpark is expected to end at approximately 8:30 pm on a specific day, a restaurant or bar near the ballpark may want to host a reverse happy hour starting at 8:30 pm on that day for the baseball fans leaving the ballpark. In order to communicate the reverse happy hour event to the departing baseball fans, the restaurant or bar can use the system described above to send an advertisement only on that day from 7:30-9:00 pm to those mobile devices within two miles of the ballpark.

The system described herein can be used to auction or broker the right to transmit the electronic coupon, as described above. The system described herein can also be used to subsidize the cost of transmitting the electronic coupon by allowing a third party to pay for an advertisement transmitted with the electronic coupon. The system described herein can further be used to arbitrage electronic coupons in different locations. These methods are described further below.

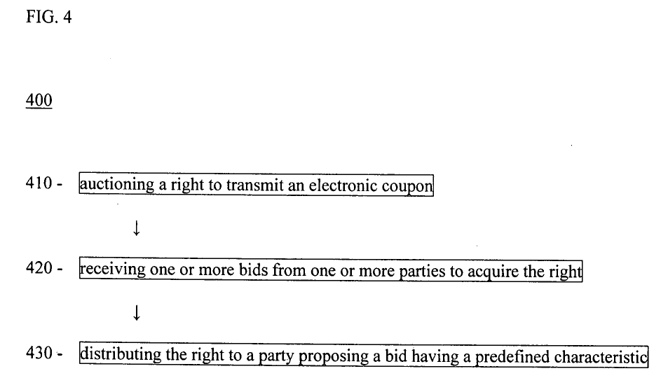

Turning to FIG. 4, a flow chart 400 illustrates a method for distributing a right to transmit an electronic coupon to mobile devices. In one embodiment, the mobile devices of flow chart 400 can be similar to devices 49 of FIG. 3. The method of flow chart 400 can be used to match producers, which can include manufacturers, merchants, retailers, content providers, advertisers, coupon distributors or broadcasters, or the like. In one embodiment, the electronic coupon of flow chart 400 can be similar to electronic coupon 53 of FIG. 3. Also, as explained in more detail below, the electronic coupon can be product specific, discount specific, both, or neither.

Flow chart 400 in FIG. 4 can include a block 410 to auction the right to transmit the electronic coupon to the mobile devices at one or more predetermined locations at one or more predetermined times on one or more predetermined days. In one embodiment, the auctioning process of block 410 can be similar to offering the right for sale to one or more potential buyers at the same time. The auctioning process of block 410 can also be similar to a live auction, or it can be similar to a passive, on-line, or electronic auction held over the Internet.

As an example, the predetermined times and days of block 410 can last for one or more seconds, minutes, days, weeks, months, or years. Also, the predetermined times and days can be specific times and days, or the predetermined times and days can be relative times and days. For instance, using the baseball example described above, the predetermined day can be the specific day of the baseball game, and the predetermined time can be the relative time to when the ninth inning of the baseball game ends without a tie score.

As another example, the one or more predetermined locations of block 410 can be based upon a global positioning system, a wireless fidelity (WiFi) positioning system, a range of one or more cellular telephone signal transmission towers, or a coordinate position. Additionally, the one or more predetermined locations can include one or more parcels of geo-spatial locations of any size or shape.

In another embodiment, the auctioning in block 410 can be for a right to transmit the electronic coupon to the mobile devices at one or more predetermined locations, but without any restrictions on the day(s) or time(s). In a different embodiment, the auctioning in block 410 can be for a right to transmit the electronic coupon to the mobile devices at one or more predetermined days, but without any restrictions on the time(s) or the location(s). In yet another embodiment, the auctioning in block 410 can be for a right to transmit the electronic coupon to the mobile devices at one or more predetermined time(s), but without any restrictions on the day(s) or the location(s). Other combinations and permutations are also contemplated.

In one embodiment, the right being auctioned in block 410 can be used to steer, divert, or attract customers to a particular place of business by: (a) conducting a first transmission at a first predetermined day, time, and a large or wide location surrounding the place of business; (b) conducting a second transmission on the same day, but at a later time and smaller or narrower location surrounding the place of business; and (c) conducting a third transmission on the same day, but at an even later time and an even smaller or narrower location surrounding the place of business. In this embodiment, directions to the place of business and the address of the place of business can be transmitted along with the electronic coupon, and the electronic coupon can be valid for only a few hours or some other short or long period of time after each transmission.

In the embodiment described in the previous paragraph, the electronic coupon can be transmitted to mobile devices at one or more predetermined locations away from the place of business offering the electronic coupon to attract consumers who are not at the place to business to visit the place of business. In a different embodiment, the electronic coupon can be transmitted to mobile devices within the place of business to attract in-store consumers to a particular department, isle, or portion of the place of business.

Flow chart 400 in FIG. 4 can continue with a block 420 to receive one or more bids from one or more parties to acquire the right. In one embodiment, block 420 can be a portion or subset of block 410. In a different embodiment, block 410 can include offering the right for sale to one or more parties, while block 420 can include, as indicated above, receiving one or more bids. In the same or different embodiment, flow chart 400 can include, between blocks 410 and 420, soliciting the one or more bids from the one or more parties to acquire the right.

Next, flow chart 400 in FIG. 4 can continue with a block 430 to distribute the right to a party of the one or more parties proposing a bid of the one or more bids having a predetermined characteristic. As an example, the predetermined characteristic can be determined by: (a) the party conducting the auction; (b) the party who originally owned or controlled the right to transmit the electronic coupon to the mobile devices, as described in block 410, and brought the right to be auctioned; and/or (c) the marketplace in which the right to transmit the electronic coupon to the mobile devices, as described in block 410, is auctioned.

In one embodiment, block 430 can further include distributing the right to the party having a highest one of the one or more bids, where the predetermined characteristic is the highest one of the one or more bids. In this embodiment, using the ballpark example describe above, the marketplace can determine or create the highest bid by valuing the location, date, and time of the foot traffic near the ballpark. The highest bid can also represent a producer's perception or expectation of future capacity, future demand, future inventory, and/or future supply for the product or service related to the electronic coupon. As an example, if the producer perceives the future inventory to be higher, then the producer's highest bid will likely be higher, but if the producer perceives the future demand to be higher, then the producer's highest bid will likely be lower. Also, if the producer perceives the value of the product to be more closely tied to the location, date, and time, then the producer's highest bid will likely be higher.

In one embodiment, after block 420 and before block 430, the auction can be closed based on an expiration of the right being auctioned or based on a predetermined expiration set by the auctioneer or the original owner of the right. Flow chart 400 can also include, between blocks 420 and 430, identifying the winner of the auction and notifying the winner of the auction. Flow chart 400 can further include, between blocks 420 and 430, negotiating additional terms between the winner of the auction and the auctioneer (including the operator of the auction system), or between the winner of the auction and a third party, for a written agreement related to the right.

In block 430, the winner of the auction can be an investor that might not offer a product or a service. Instead, the investor can acquire the right at one point in time, while hoping to be able to auction the right to another buyer at a higher price at a later point in time. In other words, the investor can offer the right to be auctioned again, thereby repeating the method of flow chart 400.

At the end of the auction, the auctioneer and/or the original owner of the right being auction can receive payment from a portion of the proceeds from the auction of the right. The payment can be based on commission and/or a fixed fee. The auctioneer and/or the original owner can also receive payment when a customer uses the electronic coupon from a mobile device after the electronic coupon is transmitted to the mobile device of the mobile devices receiving the mobile coupon at the one or more predetermined locations at the one or more predetermined times on the one or more predetermined days of block 410. In another embodiment, the auctioneer and/or the original owner receives payments at both times.

In one embodiment, after block 430, the method of flow chart 400 can include notifying a transmitter of information about the party proposing the bid having the predetermined characteristic. In this embodiment, the transmitter of information transmits the mobile coupon to the mobile devices at the one or more predetermined locations at the one or more predetermined times on the one or more predetermined days.

In the same or different embodiment, the method of flow chart 400 can include, after block 430, allowing the party winning the auction to customize the electronic coupon. The party performing the allowing action can be the auction company or a third party.

As an example, before the auction, the electronic coupon can be limited to be only for a particular type of product (such as food, sporting goods, or digital goods), only for a specific product (such as a hamburger, a baseball glove, or a downloadable game), only for a specific percentage discount for a specific product, only for a specific dollar amount discount for a specific product, only for a specific price for a specific product, or for a free specific product. In this manner, the customization of the electronic coupon can be limited to the name and address of the merchant. As an example, a digital good can include a mobile or digital game, an audio-video clip, a banner, or the like. In another example, the customizing can include the auction winner auctioning or otherwise selling the mobile coupon (with its restrictions, if any) to a third party.

As another example, the coupon customization can include allowing the party winning the auction to customize the electronic coupon to be for one or more products, and the products can be manufactured or sold by the party winning the auction or a third party. When the term “products” is used herein, it includes both products and services, unless the term “only” is used immediately before the term “products” or unless the term “products” is used in the phrase “products and services” or a similar phrase.

In the same or different embodiment, after block 430, the method of flow chart 400 can continue by transmitting the electronic coupon to the mobile devices at the one or more predetermined locations at the one or more predetermined times on the one or more predetermined days. The transmission can be performed by the operator of the auction system and/or by a third party. In this embodiment, the method can also include refusing to transmit a different electronic coupon to the electronic devices at the one or more predetermined locations at the one or more predetermined times on the one or more predetermined days.

Flow chart 400 in FIG. 4 can also provide a price index over time. The price index can trace the relative changes in the price of the auctioned right over time. As an example, the auctioned right can have the same percentage discount for a predetermined product at a predetermined location, but the value of the price index for the transmission of the electronic coupon associated with the right can be charted over time. In one embodiment, providing the price index can include creating the price index, displaying the price index during the auctioning, and/or using the price index during the auctioning. The price index can be similar to a stock market or an exchange traded product for the auctioned right.

Flow chart 400 can also include: (a) auctioning a second right to transmit a second electronic coupon to a second one or more predetermined locations at a second one or more predetermined times on a second one or more predetermined days; and (b) receiving a second one or more bids from a second one or more parties to acquire the second right. In this embodiment, providing the price index over time can include providing a first price index for transmitting the electronic coupon to the one or more predetermined locations at the one or more predetermined times on the one or more predetermined days. Providing the price index over time can also include providing a second price index for transmitting the second electronic coupon to the second one or more predetermined locations at the second one or more predetermined times on the second one or more predetermined days.

In this embodiment, the second electronic coupon can be the same as or different from the first electronic coupon. Furthermore, the first and second locations can be the same or different; the first and second times can be the same or different; and the first and second days can be the same or different. At least one of these factors, however, should be different. Different first and second locations can include overlapping first and second locations. Similarly, different first and second times and days can include overlapping first and second times and days.

In addition to providing the price indices, flow chart 400 can also include providing a unique symbol for the first price index, and providing a unique symbol for the second price index. The unique symbols can be similar to stock symbols of the New York Stock Exchange. In this embodiment, the initial price of the rights being “auctioned” can be based on prices listed on an exchange.

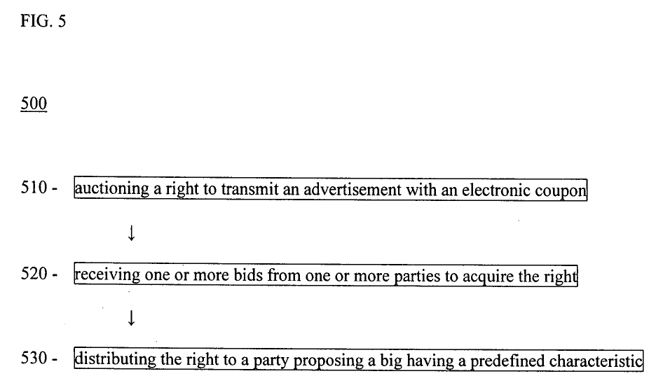

Turning to the next drawing, FIG. 5 illustrates a flow chart 500 illustrates a method for distributing a right to transmit an advertisement with an electronic coupon to mobile devices. Flow chart 500 can include: (a) a block 510 to auction the right to transmit the advertisement with the electronic coupon; (b) a block 520 to receive one or more bids from one or more parties to acquire the right; and (c) a block 530 to distribute the right to a party of the one or more parties proposing a bid of the one or more bids having a predetermined characteristic.

In one embodiment of flow chart 500, the advertisement is not a coupon, but instead, the advertisement can subsidize all or at least a portion of the discount of the electronic coupon and/or the cost of transmitting the electronic coupon. In a different embodiment, the advertisement is a different coupon that can subsidize all or at least a portion of the discount of the electronic coupon and/or the cost of transmitting the electronic coupon. As an example, the advertiser winning the bid in the method of flow chart 500 can include content providers, information service providers, producers of electronic media such as mobile games, and producers of physical and/or digital products with offline and/or online stores. The advertiser is a different party from the party that brought the electronic coupon to the auction or the party that owns or controls the right to transmit the electronic coupon. The advertiser and/or its product being advertised can complement the product being discounted by the electronic coupon.

In another embodiment of flow chart 500, the advertisement can be or include a link to a product being offered for sale at the regular retail price, at a partial discount, or at a complete discount (i.e., for free). As an example, the product can be a digital game, which can be downloaded to the mobile device receiving the coupon and the advertisement.

Flow chart 500 can be similar to flow chart 400 in FIG. 4. For example, the mobile devices of flow charts 400 and 500 can be similar to each other, and the electronic coupons of flow charts 400 and 500 can be similar to each other. Furthermore, as another example, although the right being auctioned in block 410 of FIG. 4 is different from the right being auctioned in block 510 of FIG. 5, the auctioning process can be similar in blocks 410 and 510. The receiving process of block 420 (FIG. 4) and block 520 (FIG. 5) can also be similar with the same limitations, and the distributing process of block 430 (FIG. 4) and block 530 (FIG. 5) can also be similar with the same limitations.

The auctioneer and/or original owner or controller of the right being auctioned can receive a single payment or can receive two payments in a manner similar to the description provided earlier with reference to FIG. 4, above.

In a different embodiment, aspects of the method of flow chart 400 in FIG. 4 can be combined with aspects of the method of flow chart 500 in FIG. 5. For example, when the method of flow chart 400 in FIG. 4 includes allowing the party winning the auction to customize the electronic coupon, the customization can include adding an advertisement about one or more products. In one embodiment, the advertisement is not a coupon, and the electronic coupon being auctioned can be for a predetermined product and a predetermined discount. In a different embodiment, the advertisement is a different electronic coupon. In another embodiment, a manufacturer or producer subsidizes the cost for a retailer to transmit an electronic coupon for a ten percent discount off all purchases made in a predetermined store on a predetermined day. In this embodiment, the retailer can, among other things: (a) insert a photograph of the manufacturer's product on the retailer's electronic coupon; (b) insert streaming audio and/or video; (c) insert an advertisement; and/or (d) insert a link for a photograph, streaming audio and/or video, a digital game, an advertisement or promotion, or the like.

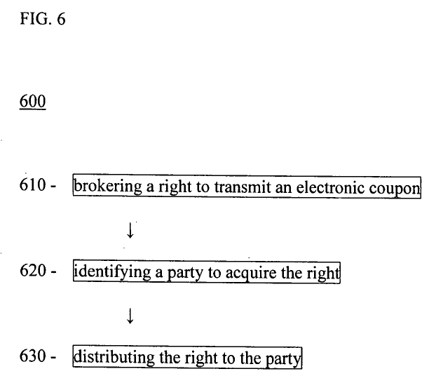

Turning to the next drawing, FIG. 6 illustrates a flow chart 600 for a method for distributing a right to transmit an electronic coupon to mobile devices. In one embodiment, the mobile devices of flow chart 600 can be similar to devices 49 of FIG. 3, and the electronic coupon of flow chart 600 can be similar to electronic coupons 53 of FIG. 3. The method of flow chart 600 can be used to match producers, which can include manufacturers, merchants, retailers, content providers, advertisers, coupon distributors or broadcasters, or the like. Also, as explained previously, the electronic coupon can be product specific, discount specific, both, or neither.

Flow chart 600 in FIG. 6 includes a block 610 to broker the right to transmit the electronic coupon to one or more predetermined locations at one or more predetermined times on one or more predetermined days. The brokering process of block 610 can also be similar to a live brokering process, or it can be similar to a passive, on-line, or electronic brokering process held over the Internet. Flow chart 600 in FIG. 6 continues with a block 620 to identify a party to acquire the right, and a block 630 to distribute the right to the party. In one embodiment, the method of flow chart 600 is a three party transaction such as a broker, an original right owner, and the right acquirer.

In one embodiment, the broker can receive payment as a fixed fee from the price paid by the party acquiring the right in block 630. In a different embodiment, the broker can receive payment as a percentage of the price paid by the party acquiring the right in the block 630. In another embodiment, the broker can receive an additional or second payment when the electronic coupon is redeemed, as explained above.

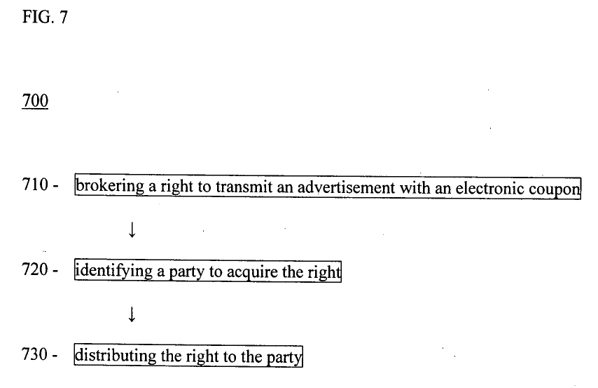

Next, FIG. 7 illustrates a flow chart 700 for a method for distributing a right to transmit an advertisement with an electronic coupon to mobile devices. Flow chart 700 can include: (a) a block 710 to broker the right to transmit the advertisement with the electronic coupon; (b) a block 720 to identify a party to acquire the right; and (c) a block 730 to distribute the right to the party.

Flow chart 700 can be similar to flow chart 600 in FIG. 6. For example, the mobile devices of flow charts 600 and 700 can be similar to each other, and the electronic coupons of flow charts 600 and 700 can be similar to each other. Furthermore, as another example, although the right being brokered in block 610 of FIG. 6 is different from the right being auctioned in block 710 of FIG. 7, the auctioning process can be similar in blocks 610 and 710. The identifying process of block 620 (FIG. 6) and block 720 (FIG. 7) can also be similar with the same limitations, and the distributing process of block 630 (FIG. 6) and block 730 (FIG. 7) can also be similar with the same limitations. The broker in flow chart 700 can receive payments in a manner similar to the payment receiving process described with reference to flow chart 600 in FIG. 6.

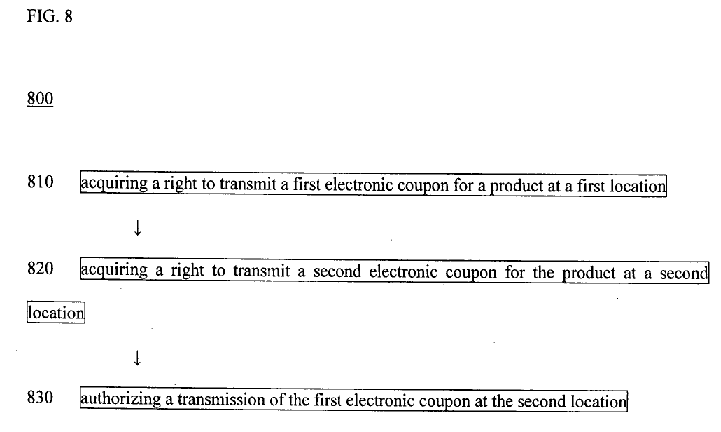

Turning to the last drawing, FIG. 8 illustrates a flow chart 800 for a method of distributing electronic coupons to mobile devices. In one embodiment, the mobile devices of flow chart 800 can be similar to devices 49 of FIG. 3, and the electronic coupon of flow chart 800 can be similar to electronic coupons 53 in FIG. 3. The method of flow chart 800 can be used to match producers, which can include manufacturers, merchants, retailers, content providers, advertisers, coupon distributors or broadcasters, or the like. Also, as explained previously, the electronic coupon can be product specific, discount specific, both, or neither.

Flow chart 800 in FIG. 8 includes: (a) a block 810 to acquire a right to transmit a first electronic coupon for a product at a first location; (b) a block 820 to acquire a right to transmit a second electronic coupon for the product at a second location; and (c) a block 830 to authorize a transmission of the first electronic coupon for the product at the second location. The method of flow chart 800 can also include receiving payment when the first electronic coupon is redeemed at the second location after the first electronic coupon is transmitted to mobile devices at the second location. In the same or a different embodiment, the party or parties acquiring the rights might need a contract with the manufacturer or retailer of the product to allow the performance of block 830 and/or to receive the payment.

In one embodiment of the method described in flow chart 800, the first electronic coupon can be for a $1.00 hamburger at a first location of a restaurant, and the second electronic coupon can be for a $0.90 hamburger at a second location of the restaurant. In this embodiment, the first and second locations can be far apart such as, for example, in different states or in different countries. In another embodiment, the first and second locations are different cities or counties within the same state. This example is an example of an arbitrage process.

The method of flow chart 800 can also include acquiring a right to transmit a third electronic coupon for the product at a third location. Afterwards, the method of flow chart 800 can include transmitting the second coupon at the third location. In this embodiment, the method of claim 800 can also include: (a) receiving a first payment when the first electronic coupon is redeemed at the second location after the first electronic coupon is transmitted to electronic devices at the first location; and (b) receiving a second payment when the second electronic coupon is redeemed at the third location after the second electronic coupon is transmitted to electronic devices at the third location.

Electronic coupons can have much more volatility and uncertainty when coupon values are tied to mobile networks, but the methods and systems described herein permit reducing exposure to stale or non-performing electronic coupon portfolios. Under these situations, electronic coupons can be modeled as commodities and options. The methods and systems described herein improve the packaging of electronic coupons and other collateral marketing materials to complement products that can be purchased remotely by consumers from their mobile devices.

Software applications can perform the actions or at least assist in the performance of the actions described for markets 17 in FIG. 1, markets 24 in FIG. 1, the tertiary market FIG. 3, and any of the methods in FIGS. 4-8. In some embodiments, the software applications can serve as getting agents of coupons distributed over mobile networks.

The systems and methods described herein may be implemented in a variety of embodiments, and the foregoing discussion of these embodiments does not necessarily represent a complete description of all possible embodiments. Rather, the detailed description of the drawings, and the drawings themselves, disclose at least one preferred embodiment, and may disclose alternative embodiments. Additionally, different aspects of different embodiments can be used together in different combinations and permutations.

For example, a party can bring to auction the right to subsidize a third party's electronic coupon right, and a party can auction the right to broker a third party's electronic coupon right. Furthermore, a party can auction the right to arbitrage a third party's electronic coupon right. Also, a party can broker the right to auction a third party's electronic coupon rights. Other variations are also contemplated.

Moreover, different aspects of the different methods of FIGS. 4-8 can be combined with each other. Also, the payments for the brokerages can also be applied to the payments for the auctioneers, and vice versa. Additionally, the party bringing the right to be auctioned or brokered can be an online business and/or a brick and mortar business. Furthermore, the methods of FIGS. 4-8 can also be used to auction, broker, or arbitrage rights to transmit electronic coupons not only to mobile devices, but also to stationary devices such as, for example, desktop computers.

Additionally, the methods described with reference to FIGS. 4-8 can be for the primary markets described in FIG. 1 with reference to markets 17. Also, the methods described with reference to FIGS. 4-8 can be between producers 10, 11, 12, and 13 (FIG. 1), among other producers, and one or more parties that facilitate or operate the primary markets. As an example, a business that sells, licenses, or operates software to conduct the transactions for the primary markets can be a party that facilitates or operates the primary markets. The secondary markets described in FIG. 1 with reference to markets 24 can be between producers 10, 11, 12, and 13, among other producers, and the tertiary markets described in FIG. 3 can be between consumers 45 (FIG. 3), on one hand, and producers 10, 11, 12, and 13 (FIG. 1) and other producers, on the other hand.

In some cases, the value of the product can be less than the value or discount of the electronic coupon associated with the product. If the auctioned electronic coupon value is worth as much as or more than the price of the product or service, then the methods described herein can also relate to rights to the products and services themselves. Accordingly, the methods described herein can permit the pricing of the auctioned rights to reflect: (a) the value of the actual products and/or services; and/or (b) the profit made from selling the products and/or services.

As another example, the methods described in FIGS. 4-8 can also be used to auction, broker, and/or arbitrage rights to transmit information, and not just electronic coupons or advertisements with electronic coupons. In one embodiment, the right being auctioned, brokered, or arbitraged can be a right to transmit an advertisement, without an accompanying electronic coupon. In another embodiment, the right being auctioned, brokered, or arbitraged can be for a product, without an accompanying electronic coupon or advertisement. As an example, the product can be a ring tone or a digital game.

Moreover, the right being auctioned in the method of flow chart 500 in FIG. 5 can have additional terms and conditions. The additional terms and conditions can include one or more predetermined transmission location, days, and/or times, as described with reference to flow chart 400 in FIG. 4. The right being brokered in the method of flow chart 700 in FIG. 7 can have similar additional terms and conditions.

Also, producers 10, 11, 12, and 13 (FIG. 1) can enter their positions, as described with reference to FIG. 1, with respect to: (a) location(s); (b) date(s); (c) date(s) and time(s); (d) location(s), date(s), and time(s); (e) location(s), date(s), time(s), and product(s)/service(s); (f) location(s), date(s), time(s), product(s)/service(s), and coupon(s); and/or (g) location(s), date(s), time(s), product(s)/service(s), coupon(s), and advertisement(s), as described with reference to FIGS. 4-8. Other variations are also contemplated. Also, each of producers 10, 11, 12, and 13 can enter their positions with respect to the positions of the other ones of producers 10, 11, 12, and/or 13. Other combinations and permutations are also contemplated.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for distributing a right to transmit an electronic coupon to mobile devices, the method comprising:
auctioning the right to transmit the electronic coupon to the mobile devices at one or more predetermined locations at one or more predetermined times on one or more predetermined days;
receiving one or more bids from one or more parties to acquire the right; and
distributing the right to a party of the one or more parties proposing a bid of the one or more bids having a predetermined characteristic.

2. The method of claim 1, wherein:
distributing the right further comprises:
distributing the right to the party having a highest one of the one or more bids; and
the predetermined characteristic comprises the highest one of the one or more bids.

3. The method of claim 1, further comprising:
transmitting the electronic coupon to the mobile devices at the one or more predetermined locations at the one or more predetermined times on the one or more predetermined days.

4. The method of claim 3, further comprising:
refusing to transmit a different electronic coupon to the electronic devices at the one or more predetermined locations at the one or more predetermined times on the one or more predetermined days.

5. The method of claim 1, further comprising:
notifying a transmitter of information about the party proposing the bid having the predetermined characteristic;
wherein the transmitter of information transmits the mobile coupon to the mobile devices at the one or more predetermined locations at the one or more predetermined times on the one or more predetermined days.

6. The method of claim 1, further comprising:
allowing the party proposing the bid having the predetermined characteristic to customize the electronic coupon.

7. The method of claim 6, wherein:
allowing the party proposing the bid having the predetermined characteristic to customize the electronic coupon further comprises:
allowing the party proposing the bid having the predetermined characteristic to customize the electronic coupon to be for one or more products.

8. The method of claim 6, wherein:
allowing the party proposing the bid having the predetermined characteristic to customize the electronic coupon further comprises:
allowing the party proposing the bid having the predetermined characteristic to customize the electronic coupon by adding an advertisement about one or more products.

9. The method of claim 8, wherein:
auctioning further comprises:
auctioning the right to transmit the electronic coupon having a predetermined content.

10. The method of claim 1, further comprising:
soliciting the one or more bids from the one or more parties to acquire the right.

11. The method of claim 1, further comprising:
receiving payment for the auctioning.

12. The method of claim 1, further comprising:
receiving payment when a party uses the electronic coupon from a mobile device after the electronic coupon is transmitted to the mobile device of the mobile devices receiving the mobile coupon at the one or more predetermined locations at the one or more predetermined times on the one or more predetermined days.

13. The method of claim 12, further comprising:
receiving payment for the auctioning.

14. The method of claim 1, wherein:
auctioning further comprises:
auctioning the right to transmit a particular type of the electronic coupon.

15. The method of claim 1, wherein:
auctioning further comprises:
auctioning the right to transmit the electronic coupon for a predetermined product.

16. The method of claim 15, wherein:
auctioning further comprises:
auctioning the right to transmit the electronic coupon for a predetermined price for the predetermined product.

17. The method of claim 1, wherein:
auctioning further comprises:
auctioning the right to transmit the electronic coupon for a predetermined discount.

18. The method of claim 1, further comprising:
providing a price index over time.

19. The method of claim 18, further comprising:
auctioning a second right to transmit a second electronic coupon to a second one or more predetermined locations at a second one or more predetermined times on a second one or more predetermined days; and
receiving a second one or more bids from a second one or more parties to acquire the second right;
wherein:
providing the price index over time further comprises.
providing a first price index for transmitting the electronic coupon to the one or more predetermined locations at the one or more predetermined times on the one or more predetermined days; and
providing a second price index for transmitting the second electronic coupon to the second one or more predetermined locations at the second one or more predetermined times on the second one or more predetermined days.

20. The method of claim 19, further comprising:
providing a unique symbol for the first price index; and
providing a unique symbol for the second price index.

21. A method for distributing a right to transmit an advertisement with an electronic coupon to mobile devices, the method comprising:
auctioning the right to transmit the advertisement with the electronic coupon;
receiving one or more bids from one or more parties to acquire the right; and
distributing the right to a party of the one or more parties proposing a bid of the one or more bids having a predetermined characteristic.

22. The method of claim 21, further comprising:
receiving payment when a party uses the electronic coupon from a mobile device after the electronic coupon is transmitted to the mobile device of the mobile devices.

23. The method of claim 22, further comprising:
receiving payment for the auctioning.

24. A method for distributing a right to transmit an electronic coupon to mobile devices, the method comprising:
brokering the right to transmit the electronic coupon to one or more predetermined locations at one or more predetermined times on one or more predetermined days;
identifying a party to acquire the right; and
distributing the right to the party.

25. The method of claim 24, further comprising:
receiving payment when a party uses the electronic coupon from a mobile device after the electronic coupon is transmitted to the mobile device of the mobile devices at the one or more predetermined locations at the one or more predetermined times on the one or more predetermined days.

26. The method of claim 25, further comprising:
receiving payment for the brokering.

27. A method for distributing a right to transmit an advertisement with an electronic coupon to mobile devices, the method comprising:
brokering the right to transmit the advertisement with the electronic coupon;
identifying a party to acquire the right; and
distributing the right to the party.

28. The method of claim 27, further comprising:
receiving payment when a party uses the electronic coupon from a mobile device after the electronic coupon is transmitted to the mobile device of the mobile devices at the one or more predetermined locations at the one or more predetermined times on the one or more predetermined days.

29. The method of claim 28, further comprising:
receiving payment for the brokering.

30. A method of distributing electronic coupons to mobile devices comprising:
acquiring a right to transmit a first electronic coupon for a product at a first location;
acquiring a right to transmit a second electronic coupon for the product at a second location; and
authorizing a transmission of the first electronic coupon for the product at the second location.

31. The method of claim 30 further comprising:
receiving payment when the first electronic coupon is redeemed at the second location after the first electron coupon is transmitted to mobile devices.

32. The method of claim 30 further comprising:
acquiring a right to transmit a third electronic coupon for the product at a third location; and
transmitting the second coupon at the third location.

33. The method of claim 32 further comprising:
receiving a first payment when the first electronic coupon is redeemed at the second location after the first electronic coupon is transmitted to electronic devices at the first location; and
receiving a second payment when the second electronic coupon is redeemed at the third location after the second electronic coupon is transmitted to electronic devices at the third location.
